(19) United States
(12) Patent Application Publication
(10) Pub. No.: US 2012/0079874 A1
(43) Pub. Date: Apr. 5, 2012

(54) Chromatography Columns

(76) Inventors: James Anderson, JR., Arlington Heights, IL (US); Kiran Chodavarapu, Ellicott City, MD (US); Titus Presana, Chennai (IN); Sethulingam Sethupackiam, Chennai (IN); Louie Goldsmith, Arlington Heights, IL (US)

(21) Appl. No.: 13/133,733

(22) PCT Filed: Dec. 10, 2009
(86) PCT No.: PCT/US2009/006498

§ 371 Date: Dec. 12, 2011

(51) Int. Cl. G01N 30/02; B32B 37/14

(52) U.S. Cl. 73/61.53; 156/293

(57) ABSTRACT

Chromatography columns are disclosed. Methods of making chromatography columns and methods of using chromatography columns are also disclosed.

### FIELD OF THE INVENTION

The present invention is directed to chromatography columns, such as high pressure flash columns, methods of making chromatography columns, and methods of using chromatography columns.

### BACKGROUND OF THE INVENTION

There is a need in the art for chromatography columns, such as high pressure flash columns, that have a simple design, is manufacturer easily, and can withstand relatively high pressure applications.

### SUMMARY OF THE INVENTION

The present invention addresses some of the need in the art discussed above by the discovery of new chromatography columns, such as high pressure flash columns, that have a simple design and are capable of withstanding a column operational pressure equal to or greater than 7 kg/cm² (i.e., 100 psi) and a pressure to column cross sectional area of at least about 1.00. In one exemplary embodiment of the present invention, the chromatography column comprises (1) a tubular column body comprising an open end, a column flange extending outwardly from and integrally connected to the open end, a closed end, and an outlet port positioned within the closed end; (2) a cap member comprising a cap member flange and an integrally connected inlet port positioned within the cap member; and (3) one or more bonds connecting a lower surface of the cap member flange to an upper surface of the column flange, wherein the chromatography column is capable of withstanding a column operational pressure equal to or greater than about 7 kg/cm² (i.e., 100 psi) and a pressure to column cross sectional area of at least about 1.00.

In a further exemplary embodiment of the present invention, the chromatography column comprises (1) a tubular column body having an open end, a closed end, an outlet port positioned within the closed end, and a thread-less outer side surface extending from the open end to the closed end; and (2) a cap member comprising an inlet port integrally connected to and positioned within the cap member, the cap member being bonded to the tubular column body so as to seal the open end, wherein the chromatography column is capable of withstanding a column operational pressure equal to or greater than about 7 kg/cm² (i.e., 100 psi) and a pressure to column cross sectional area of at least about 1.00.

In yet a further exemplary embodiment of the present invention, the chromatography column comprises (1) a tubular column body having an open end, a closed end, and an outlet port positioned within the closed end; and (2) a cap member sealing the open end of the tubular column body, the cap member comprising (i) an inlet port integrally connected to and positioned within the cap member and (ii) one or more outer cap member surfaces in contact with the tubular column body, the one or more outer cap member surfaces being thread-less surfaces, wherein the chromatography column is capable of withstanding a column operational pressure equal to or greater than about 7 kg/cm² (Le., 100 psi) and a pressure to column cross sectional area of at least about 1.00.

The present invention is also directed to methods of making chromatography columns. In one exemplary method, the method of making a chromatography column comprises forming a tubular column body; forming a cap member; and connecting the cap member to the tubular column body without the use of engaging threads. In some embodiments, the connecting step is an ultrasonic welding step, wherein an outer surface of the cap member is ultrasonically bonded to an outer surface of the tubular column body. The methods of making chromatography columns may comprise a number of additional steps, such as steps of providing one or more components within a column volume of the tubular column body (e.g., rigid support media, filters, etc.).

The present invention is further directed to methods of using chromatography columns. In one exemplary method of using a chromatography column, the method comprises a method of analyzing a sample that potentially contains at least one analyte, wherein the method comprises the step of introducing the sample into a chromatography column containing a rigid support media, wherein the rigid support media comprises a plurality of inorganic particles, organic particles, porous monoliths or other stationary phases used in chromatography, and the chromatography column comprises a tubular column body bonded to a cap member without the use of engaging threads.

These and other features and advantages of the present invention will become apparent after a review of the following detailed description of the disclosed embodiments and the appended claims.

### BRIEF DESCRIPTION OF THE FIGURES

FIG. 1 depicts an exemplary chromatography column of the present invention comprising an exemplary cap member and an exemplary tubular column body;

FIG. 2 depicts a cross-sectional view of the exemplary chromatography column along line A-A shown in FIG. 1 when the exemplary cap member is attached to the exemplary tubular column body;

FIGS. 3A-3B depict detailed views of reinforcing ribs on the exemplary tubular column body shown in FIG. 1;

FIG. 4A depicts a detailed view of an exemplary lower surface of the exemplary cap member shown in FIG. 1; and

FIG. 4B depicts a cross-sectional view of a lower surface of the exemplary cap member along line B-B shown in FIG. 4A.

### DETAILED DESCRIPTION OF THE INVENTION

To promote an understanding of the principles of the present invention, descriptions of specific embodiments of the invention follow and specific language is used to describe the specific embodiments. It will nevertheless be understood that no limitation of the scope of the invention is intended by the use of specific language. Alterations, further modifications, and such further applications of the principles of the present invention discussed are contemplated as would normally occur to one ordinarily skilled in the art to which the invention pertains.

It must be noted that as used herein and in the appended claims, the singular forms “a”, “and”, and “the” include plural referents unless the context clearly dictates otherwise. Thus, for example, reference to “a solvent” includes a plurality of such solvents and reference to “solvent” includes reference to one or more solvents and equivalents thereof known to those skilled in the art, and so forth.

“About” modifying, for example, the quantity of an ingredient in a composition, concentrations, volumes, process temperatures, process times, recoveries or yields, flow rates, and like values, and ranges thereof, employed in describing the embodiments of the disclosure, refers to variation in the numerical quantity that may occur, for example, through typical measuring and handling procedures; through inadvertent error in these procedures; through differences in the ingredients used to carry out the methods; and like proximate considerations. The term “about” also encompasses amounts that differ due to aging of a formulation with a particular initial concentration or mixture, and amounts that differ due to mixing or processing a formulation with a particular initial concentration or mixture. Whether modified by the term “about” the claims appended hereto include equivalents to these quantities.

As used herein, the term “chromatography” means a physical method of separation in which the components to be separated are distributed between two phases, one of which is stationary (stationary phase) while the other (the mobile phase) moves in a definite direction.

As used herein, the term “liquid chromatography” means the separation of mixtures by passing a fluid mixture dissolved in a “mobile phase” through a column comprising a stationary phase, which separates the analyte (i.e., the target substance) from other molecules in the mixture and allows it to be isolated.

As used herein, the term “mobile phase” means a fluid liquid, a gas, or a supercritical fluid that comprises the sample being separated and/or analyzed and the solvent that moves the sample comprising the analyte through the column. The mobile phase moves through the chromatography column or cartridge (i.e., the container housing the stationary phase) where the analyte in the sample interacts with the stationary phase and is separated from the sample.

As used herein, the term “stationary phase” Oar “media” means material fixed in the column or cartridge that selectively adsorbs the analyte from the sample in the mobile phase separation of mixtures by passing a fluid mixture dissolved in a “mobile phase” through a column comprising a stationary phase, which separates the analyte to be measured from other molecules in the mixture and allows it to be isolated.

As used herein, the term “flash chromatography” means the separation of mixtures by passing a fluid mixture dissolved in a “mobile phase” under pressure through a column comprising a stationary phase, which separates the analyte (i.e., the target substance) from other molecules in the mixture and allows it to be isolated.

As used herein, the term “fluid” means a gas, liquid, and supercritical fluid.

As used herein, the term “substantially” means within a reasonable amount, but includes amounts which vary from about 0% to about 50% of the absolute value, from about 0% to about 40%, from about 0% to about 30%, from about 0% to about 20% or from about 0% to about 10%.

The present invention is directed to chromatography columns (i) that have a simple design (e.g., only two column forming components) and (ii) are capable of withstanding a column operational pressure equal to or greater than 7 kg/cm² (i.e., 100 psi) and a pressure to column cross sectional area of at least about 1.00. The present invention is further directed to methods of making chromatography columns (i) that have a simple design and (ii) are capable of withstanding a column operational pressure equal to or greater than 7 kg/cm² (i.e., 100 psi) and a pressure to column cross sectional area of at least about 1.00, as well as methods of using chromatography columns to analyze a given sample. In other embodiments, the pressure to column cross sectional area may be at least 1.5, at least 2.0, at least 2.5, at least 3.0, at least 3.5, at least 5.0, etc. in 0.5 increments up to and exceeding 100.0. Examples are shown in Table 1 below.

TABLE 1

| | | Diam- | | | | | Pres- | |
|---|---|---|---|---|---|---|---|---|
| Cartridge | | eter | Length | | xA | Volume | sure | Ratio |
| Size | | (cm) | (cm) | L/D | (Cm2) | (cm3) | (pst) | (P/xA) |
| 4 | g | 1.40 | 6.50 | 4.64 | 1.54 | 10.01 | 200 | 129.92 |
| 330 | g | 6.00 | 23.40 | 3.90 | 28.27 | 661.62 | 200 | 7.07 |
| 330 | g | 6.00 | 23.40 | 3.90 | 28.27 | 661.62 | 100 | 3.54 |
| 330 | g | 2.05 | 50.00 | 24.36 | 3.31 | 661.62 | 100 | 30.23 |
| 1000 | g | 6.00 | 78.30 | 13.05 | 28.27 | 2213.94 | 100 | 3.54 |
| 1000 | g | 8.97 | 35.00 | 3.90 | 63.26 | 2213.94 | 100 | 1.58 |

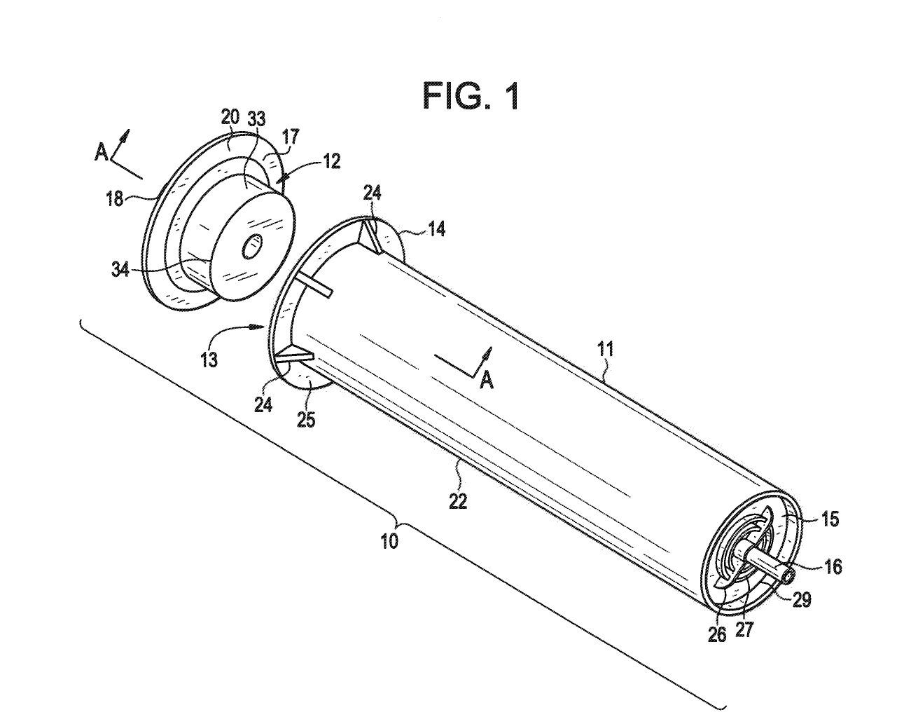

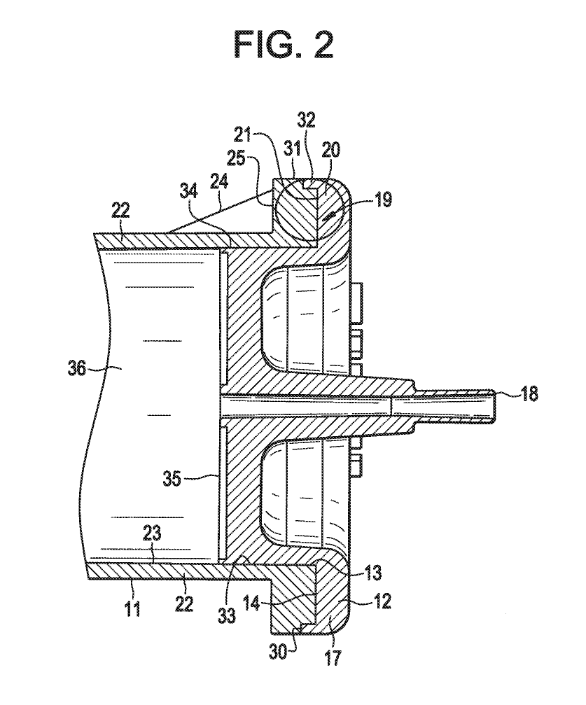

One exemplary chromatography column of the present invention is shown in FIG. 1. As shown in FIG. 1, exemplary chromatography column 10 comprises tubular column body 11 comprising an open end 13, a column flange 14 extending outwardly from and integrally connected to open end 13, a closed end 15, and an outlet port 16 positioned within closed end 15; (2) a cap member 12 comprising a cap member flange 17 and an integrally connected inlet port 18 positioned within cap member 12; and (3) one or more bonds (see, for example, bond areas 19 in FIG. 2) connecting a lower surface 20 of cap member flange 17 to an upper surface 21 of column flange 14. A cross-sectional view of exemplary chromatography column 10 as viewed along line A-A in FIG. 1 when exemplary cap member 12 is attached to exemplary tubular column body 11 is provided in FIG. 2.

As shown in FIG. 2, lower surface 20 of exemplary cap member 12 is attached to upper surface 21 of exemplary tubular column body 11 at one or more bond areas 19. In some desired embodiments, one or more bond areas 19 comprise one or more ultrasonically welded bond areas between lower surface 20 of exemplary cap member 12 and upper surface 21 of exemplary tubular column body 11.

As shown in FIGS. 1-2, the chromatography columns of the present invention may comprise as few as two column forming components. As discussed above, a number of additional components may be used in combination with the above-described tubular column body and cap member. Further, the above-described tubular column body and cap member may each independently comprise structural features in addition to those described above. A description of possible components and structural features is provided below.

### I. Chromatography Column Components and Configurations

The chromatography columns of the present invention may comprise one or more of the following components.

A. Chromatography Column Components

1. Outer Column Components

The chromatography columns of the present invention comprise the following outer components. As used herein, the term “outer components” is used to describe chromatography column components that form at least a portion of an outer surface of the chromatography column.

a. Tubular Column Body

The chromatography columns of the present invention comprise a tubular column body such as exemplary tubular column body 11 of exemplary chromatography column 10 shown in FIGS. 1-2. As discussed above and as shown in FIGS. 1-2, exemplary tubular column body 11 comprising open end 13, column flange 14 extending outwardly from and integrally connected to open end 13, closed end 15, and outlet port 16 positioned within closed end 15. In addition, exemplary tubular column body 11 comprising an outer side surface 22 and an inner side surface 23 extending from open end 13 to closed end 15. In some desired embodiments, outer side surface 22 and/or inner side surface 23 each independently comprise a thread-less surface. As used herein, the term “thread-less” surface is used to describe a surface that is free of any engaging threads (e.g., male or female threads, such as found on a bolt and nut, that engage with corresponding female or male threads) or portions of engaging threads (i.e., engaging threads that extend along less than a complete circumference of an object).

In some embodiments of the present invention, the tubular column body comprises a thread-less outer side surface (e.g., outer side surface 22) extending from the open end to the closed end of the tubular column body. In some embodiments of the present invention, the tubular column body comprises a thread-less inner side surface (e.g., inner side surface 23) extending from the open end to the closed end of the tubular column body. In some embodiments of the present invention, the tubular column body comprises a thread-less outer side surface (e.g., outer side surface 22) and a thread-less inner side surface (e.g., inner side surface 23) extending from the open end to the closed end of the tubular column body.

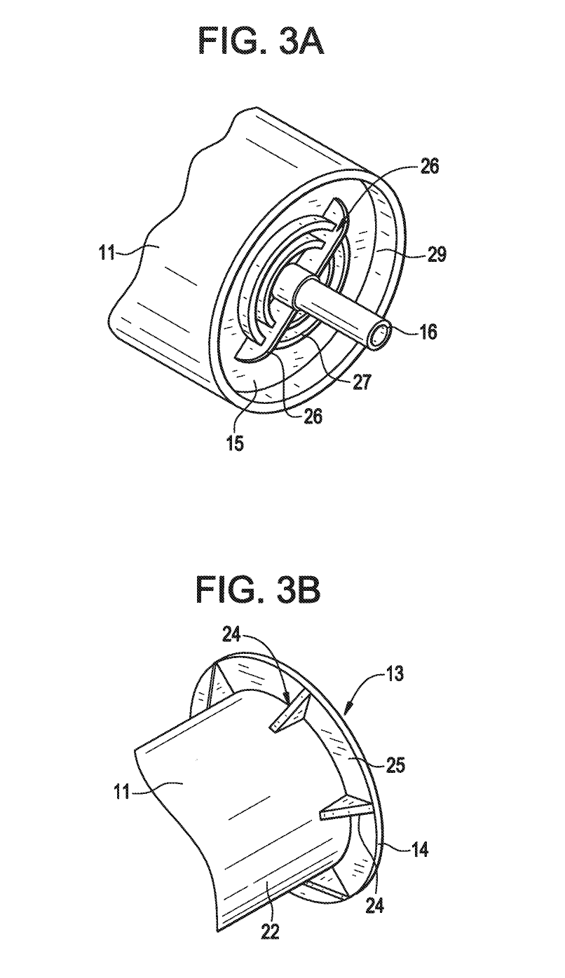

The tubular column body may further comprise one or more reinforcing ribs extending along an outer surface of tubular column body to add structural integrity to the tubular column body. For example, as shown in FIGS. 1-2 and 38, exemplary tubular column body 11 may comprise one or more first reinforcing ribs 24 extending from a lower surface 25 of column flange 14 to outer side surface 22 of tubular column body 11. Also, as shown in FIGS. 1 and 3A, exemplary tubular column body 11 may comprise one or more second reinforcing ribs 26, 27 extending along an outer end surface 28 of closed end 15 between outlet port 16 and an outer periphery 29 of closed end 15. As shown in FIG. 3A, the one or more second reinforcing ribs may comprise second reinforcing ribs 26 extending radially outward from outlet port 16, as well as second reinforcing ribs 27 forming concentric rings/ridges (or partial rings/ridges) around outlet port 16.

In some embodiments, the column flange, such as column flange 14 of exemplary tubular column body 11, may further comprise one or more surface undulations that further enhance connection of the tubular column body with a cap member. For example, as shown in FIG. 2, column flange 14 comprises an outer peripheral indentation 30 extending along an outer periphery 31 of column flange 14. Outer peripheral indentation 30 may engage with an outer rib 32 positioned along at least a portion of lower cap member surface 21 of cap member 12.

Although not shown in FIGS. 1 and 3A, it should be noted that outlet port 16 positioned within closed end 15 may further comprise a luer tip for connecting outlet port 16 to other components in the chromatography system.

In an alternative embodiment according to the present invention, the closed end 15 may alternatively be a cap member (not shown in FIG. 3A) that is also fixed on the tubular column body in some fashion so as to withstand high operational pressures, such as by ultrasonic welding.

In an alternative embodiment according to the present invention, the closed end 15 may alternatively be a cap member (not shown in FIG. 3A) that is also fixed on the tubular column body in some fashion so as to withstand high operational pressures, such as by ultrasonic welding.

The tubular column body may be formed from a variety of materials. In some desired embodiments, tubular column body comprises an inert thermoplastic material. In addition, it is desirable for the inert thermoplastic material to be transparent or translucent when formed into a tubular column body. Suitable inert thermoplastic materials include, but are not limited to, high density polyethylenes (HDPE), polypropylene homopolymers (PP), polypropylene copolymers (e.g., polypropylene/polyethylene copolymers), polypropylene random copolymers (e.g., polypropylene/polyethylene copolymers) (PP-R), polymethylpentane, polytetrafluoroethylene (PTFE), polyamides, polyimides, polyamide-imides, polyacrylates, polycarbonates, polystyrenes, acrylonitriles, acetonitrile-butadiene polymers, styrene polymers, and mixtures thereof.

In one desired embodiment, the tubular column body comprises an inert thermoplastic material in the form of a polypropylene random copolymer (PP-R). One commercially available polypropylene random copolymer (PP-R) suitable for use in the present invention comprises a polypropylene random copolymer (PP-R) commercially available under the trade designation REPOL® SRM100NC random copolymer from Reliance Polymers, a division of Reliance Industries Limited (Mumbai, India).

b. Cap Member

The chromatography columns of the present invention also comprise a cap member such as exemplary cap member 12 of exemplary chromatography column 10 shown in FIGS. 1-2. As discussed above and as shown in FIGS. 1-2, exemplary cap member 12 comprising cap member flange 17 and integrally connected inlet port 18 positioned within cap member 12. As shown in FIG. 2, exemplary cap member 12 may further comprise a vertically extending side wall surface 33 that contacts inner side surface 23 of tubular column body 11 along open end 13. Vertically extending side wall surface 33 may form a lower outer periphery 34 of cap member 12. Desirably, substantially all of lower outer periphery 34 of cap member 12 contacts inner side surface 23 of tubular column body 11 along open end 13.

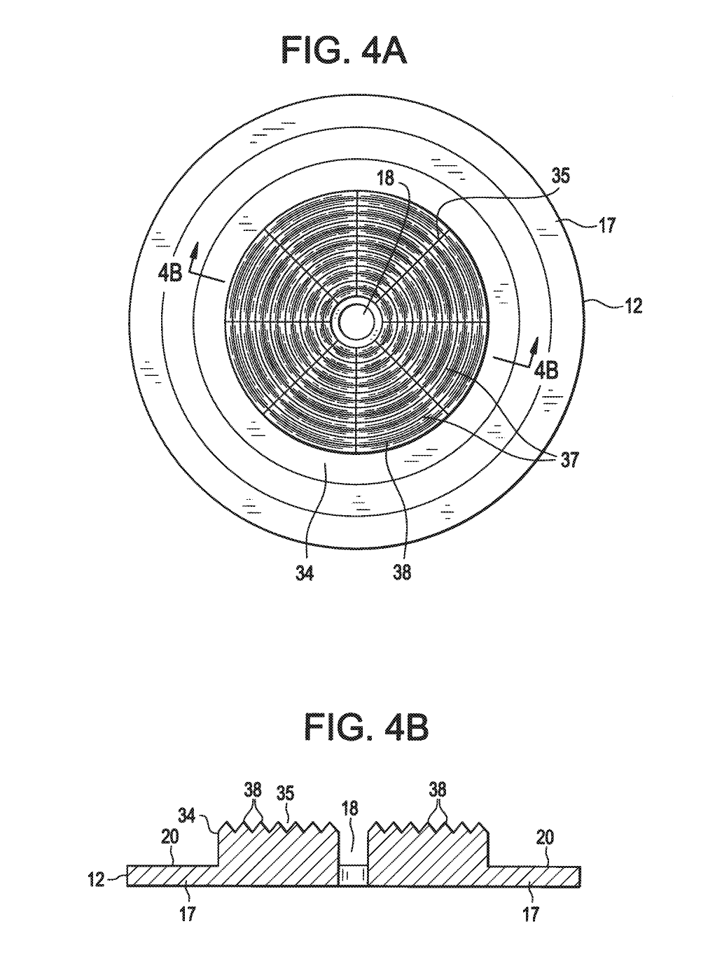

As shown in FIG. 4A, exemplary cap member 12 may further comprise a lower cap surface 35 bound by lower outer periphery 34. Lower cap surface 35 forms an upper boundary of a column volume 36 within tubular column body 11. In some embodiments, lower cap surface 35 has a surface configuration that enables substantially uniform distribution of an incoming fluid across a cross-sectional area of column volume 36. For example, exemplary lower cap surface 35 comprises grooves 37 extending radially from a location proximate inlet port 18 to lower outer periphery 34. Exemplary lower cap surface 35 also comprises a pattern of ridges 38 extending along lower cap surface 35 between grooves 37.

Any pattern of ridges 38 may be utilized so as to enable a substantially uniform distribution of an incoming fluid (not shown) across lower cap surface 35 and into a cross-sectional area of column volume 36. FIG. 4B depicts an exemplary cross-sectional view of lower cap surface 35 along line B-B shown in FIG. 4A. As shown in FIG. 4B, ridges 38 extend along lower cap surface 35 from a location proximate inlet port 18 to lower outer periphery 34.

As noted above, exemplary cap member 12 may comprise one or more outer cap member surfaces (e.g., lower cap member surface 21 and vertically extending side wall surface 33) in contact with surface of tubular column body 11 (e.g., upper surface 21 of column flange 17 and inner side surface 23 of tubular column body 11). Desirably, the one or more outer cap member surfaces (i.e., in contact with tubular column body 11) are thread-less surfaces.

In addition, as noted above, cap member 12 may comprise a cap flange (e.g., cap flange 17) having a cap flange lower surface (e.g., lower cap member surface 21) that contacts and is bonded to an end surface of tubular column body 11 at open end 13. In one desired embodiment, cap member 12 is bonded to an upper surface of a column flange on the tubular column body (e.g., upper surface 21 of column flange 17).

In some embodiments, cap flange lower surface 21 is substantially perpendicular to vertically extending side wall surface 33 of cap member 12. In this embodiment, vertically extending side wall surface 33 contacts inner side surface 23 of tubular column body 11 along open end 11, while lower cap member surface 21 contacts and is bonded to (e.g., via ultrasonic welding) upper surface 21 of column flange 17.

Although not shown in FIG. 2, it should be noted that inlet port 18 positioned within cap member 12 may further comprise a luer tip for connecting inlet port 18 to other components in the chromatography system.

Like the tubular column body described above, the cap member may be formed from a variety of materials, desirably, an inert thermoplastic material. Suitable inert thermoplastic materials for forming the cap member include, but are not limited to, the above-described polymers for forming the tubular column body.

In one desired embodiment, the cap member comprises an inert thermoplastic material in the form of a polypropylene random copolymer (PP-R).

2. Inner Column Components

The chromatography columns of the present invention may comprise one or more of the following inner components. As used herein, the term “inner components” is used to describe chromatography column components that are positioned within a column volume within the tubular column body. The inner components do not form any portion of an outer surface of the chromatography column.

a. Separation Media

The chromatography columns of the present invention may further comprise any separation media suitable for use in a chromatography column. The separation media (not shown) may be positioned within at least a portion of column volume 36 enclosed by tubular column body 11 and cap member 12.

Any separation media used in chromatography columns may be used in the present invention. Suitable types of separation media include, but are not limited to, rigid support media, such as inorganic particles as disclosed in U.S. Pat. No. 6,802,966, the disclosure of which is incorporated herein by reference in its entirety. Other suitable media include, but are not limited to, polymeric particles, organic or inorganic membranes, and inorganic or organic monoliths. Due to the ability of the chromatography columns of the present invention to withstand high pressures, this allows the use of smaller media (e.g., less than 50 microns), which typically generate high back pressures.

b. Pistons

The chromatography columns of the present invention may further comprise a piston (not shown) movable within tubular column body 11. The piston may be used to hold packing material within the chromatography column in place. The piston moves up or down within tubular column body 11 to compensate for changes in the volume of the packing materials that may occur from time to time. A description of chromatography columns utilizing a piston is disclosed in U.S. Pat. No. 5,951,873, the disclosure of which is incorporated herein by reference in its entirety.

C. Springs

The chromatography columns of the present invention may further comprise one or more springs (not shown) positioned within tubular column body 11. Springs may be used to move a piston within tubular column body 11 to compensate for changes in the volume of the packing material that may occur from time to time, for example, due to particle swelling or shrinking or rearrangement of the packed bed. A description of chromatography columns utilizing a spring assembly is disclosed in U.S. Pat. No. 5,951,873, the disclosure of which is incorporated herein by reference in its entirety.

d. Threaded Spacer

The chromatography columns of the present invention may further comprise a threaded spacer (not shown). A spacer may be positioned within tubular column body 11. A spacer may be used to compress a spring so as to apply pressure against a piston within tubular column body 11. Spacers may be used to secure the interior components (e.g., guide tube, piston, spring washers and separation media) within a column. A description of chromatography columns utilizing a threaded spacer is disclosed in U.S. Pat. No. 5,951,873 (see upper spring engaging member 56 in the '873 patent), the disclosure of which is incorporated herein by reference in its entirety.

B. Chromatography Column Configurations

The chromatography columns of the present invention may have a variety of sizes, shapes, and configurations as described below.

1. Tubular Column Body Cross-Sectional Shape

As shown in FIG. 1, exemplary tubular column body 11 has a cylindrical shape and a circular cross-sectional flow area; however, it should be understood that exemplary tubular column body 11 could have other cross-sectional configurations. Suitable cross-sectional configurations include, but are not limited to, rectangular, square, pentagon, triangular, and hexagonal cross-sectional configurations.

2. Tubular Column Body Dimensions

The tubular column body of the chromatography columns of the present invention may have a variety of sizes depending on the use of the chromatography column. For example, the tubular column body may have any height (also referred to herein as the column length), although the tubular column body typically has an overall height of less than about 1 meters (m). In some embodiments, the tubular column body of the present invention has a height (or length) ranging from about 2.5 cm (1 in) to about 125 cm (50 in).

The tubular column body typically has the following features: (1) a tubular column body inner dimension (e.g., inner diameter) ranging from about 0.6 cm (0.25 in) to about 12.5 cm (5.0 in); (2) a column flange outer dimension (e.g., outer diameter), when present, ranging from about 2.39 cm (0.94 in) to about 8.64 15.5 cm (3.4 6.2 in); (3) up to eight first reinforcing ribs (e.g., first reinforcing ribs 24 extending from lower surface 25 of column flange 14 to outer side surface 22 of tubular column body 11), and more typically, about six first reinforcing ribs; (4) an average first reinforcing rib thickness, when present, ranging from about 1.02 mm (0.04 in) to about 1.70 mm (0.067 in); (5) up to eight luer tip ribs, when present, in a given luer tip, and more typically, from about four to about six ribs; and (6) a column volume capacity ranging from about 4 grams (g) of a stationary phase (e.g., silica particles) to about 330 g 1000 g.

3. Cap Member Dimensions

The cap member (e.g., exemplary cap member 12) typically has the following features: (1) a cap member base outer dimension (e.g., an outer diameter of lower outer periphery 34) ranging from about 0.6 cm (0.25 in) to about 12.5 cm (5.0 in); (2) a cap flange outer dimension (e.g., an outer diameter of cap flange 17) ranging from about 1.25 cm (0.5 in) to about 15.0 cm (6.0 in); and (3) a cap member height ranging from about 1.52 cm (0.60 in) to about 2.39 cm (0.94 in).

4. Pressure Capacity

Chromatography columns of the present invention may be constructed from the above-referenced materials in order to withstand an internal operational pressure that varies depending on the end use of a given column. Typically, chromatography columns of the present invention are constructed to have an operational pressure capacity of up to or greater than about 7 kg/cm² (i.e., 100 psi) and a pressure to column cross sectional area of at least about 1.00.

5. Column Outer Surface Configurations

In one desired embodiment of the present invention, chromatography columns are configured such that an outer surface of a given column extending from inlet port 18 to outlet port 16 consists solely of cap member 12 and tubular column body 11. In other words, only two components, namely, cap member 12 and tubular column body 11, contribute to an overall outer surface of the column.

Methods of Making Chromatography Columns

The present invention is also directed to methods of making chromatography columns. In one exemplary method, the method of making a chromatography column comprises forming a tubular column body (e.g., exemplary tubular column body 11); forming a cap member (e.g., exemplary cap member 12); and connecting the cap member to an open end of the tubular column body.

Each of the steps of (i) forming a tubular column body (e.g., exemplary tubular column body 11) and (ii) forming a cap member (e.g., exemplary cap member 12) may independently comprise a conventional shaping step. Suitable shaping steps include, but are not limited to, a thermoforming step such as injection molding and extrusion; and sintering and machining a given part. Desirably, each of the steps of (i) forming a tubular column body and (ii) forming a cap member independently comprises injection molding steps.

The connecting step integrally attaches the cap member (e.g., exemplary cap member 12) to an open end of the tubular column body without the use of engaging threads (i.e., male and corresponding female threads). In desired embodiments, the connecting step integrally attaches one or more thread-less surfaces of the cap member (e.g., exemplary cap member 12) to one or more thread-less surfaces of the tubular column body (e.g., exemplary tubular column body 11) proximate an open end of the tubular column body (e.g., open end 13 of exemplary tubular column body 11).

The connecting step desirably results in one or more bonds between the cap member (e.g., exemplary cap member 12) and an open end of the tubular column body. In desired embodiments, the connecting step comprises an ultrasonic welding step, wherein at least one outer surface of the cap member (e.g., exemplary cap member 12) is ultrasonically welded to at least one outer surface of the tubular column body (e.g., exemplary tubular column body 11) so as to seal the open end of the tubular column body (e.g., open end 13 of exemplary tubular column body 11).

Any degree of bonding may be used between one or more outer surfaces of the cap member (e.g., exemplary cap member 12) and one or more outer surfaces of the tubular column body (e.g., exemplary tubular column body 11) as long as the resulting column is capable of withstanding a column operational pressure equal to or greater than 7 kg/cm² (i.e., 100 psi) and a pressure to column cross sectional area of at least about 1.00. Typically, multiple bond areas (e.g., bond areas 19) are positioned around an outer periphery of the cap member (e.g., exemplary cap member 12) and a corresponding outer surface of the tubular column body (e.g., exemplary tubular column body 11) proximate the open end of the tubular column body (e.g., open end 13 of exemplary tubular column body 11.

In the above-described methods of making a chromatography column, a given method may include any number of additional steps. Suitable additional steps may include, but are not limited to, testing the operational pressure capacity of the resulting chromatography column; at least partially filling a column volume of the tubular column body with a rigid support material, such as any of the above-described rigid support materials; at least partially filling the column volume of the tubular column body with a first buffer solution to encapsulate the rigid support material; inserting a piston, spring and/or threaded rod into the chromatography column to engage, and/or compress and/or retain the rigid support material within a desired area of the column; and connecting the chromatography column via inlet and outlet ports to other components within a chromatography system.

Methods of Using Chromatography Columns

The present invention is further directed to methods of using chromatography columns. In one exemplary method of using a chromatography column, the method comprises a method of analyzing a sample that potentially contains at least one analyte, wherein the method comprises the step of introducing the sample into a chromatography column containing a rigid support media, wherein the rigid support media comprises a plurality of inorganic particles, organic particles, porous monoliths or other stationary phases used in chromatography, and the chromatography column comprises a tubular column body (e.g., exemplary tubular column body 11) bonded to a cap member (e.g., exemplary cap member 12). The rigid support media may comprise a plurality of inorganic particles such as those disclosed in U.S. Pat. No. 6,802,966, the disclosure of which is incorporated herein by reference in its entirety. Other rigid support materials may comprise organic particles, inorganic or organic monoliths or membranes.

The method of analyzing a sample may further comprise one or more of the following steps: allowing the sample to come into contact with the rigid support; rinsing the rigid support to wash away any sample components other than the one or more analytes; introducing an eluent solution into the column so that the eluent solution comes into contact with the one or more analytes bound to the rigid support; allowing the eluent solution to remain in contact with the rigid support for a period of time so as to form an eluent sample, flowing the eluent sample from the column to a detector and/or a fraction collector. Typically, the eluent solution remains in contact with the rigid support for a period of time ranging from about 5 minutes to about 15 minutes.

The chromatography column of the present invention may be utilized in a variety of chromatography systems, including flash chromatography systems. For example, the column may be used in most flash systems, such as the flash REVELERIS™ system (available from Grace Davison Discovery Sciences), Teledyne Isco CombiFlash® & RF, Biotage Isolera, Analogix SimpliFlash, Interchim PuriFlash 430, or the like.

### EXAMPLES

The present invention is further illustrated by the following examples, which are not to be construed in any way as imposing limitations upon the scope thereof. On the contrary, it is to be clearly understood that resort may be had to various other embodiments, modifications, and equivalents thereof which, after reading the description herein, may suggest themselves to those skilled in the art without departing from the spirit of the present invention and/or the scope of the appended claims.

### Example 1

### Preparation of a Chromatography Column

A tubular column body having a configuration substantially identical to exemplary tubular column body 11 shown in FIG. 1 was formed from REPOL® SRM100NC random copolymer (Reliance Polymers, Mumbai, India) via a first injection molding step. The resulting tubular column body had the following features: (1) a height (or length) of 25.4 cm (9.99 in); (2) a tubular column body inner diameter of 6.06 cm (2.387 in); (3) a column flange outer diameter of 8.64 cm (3.4 in); (4) six first reinforcing ribs (e.g., first reinforcing ribs 24 extending from lower surface 25 of column flange 14 to outer side surface 22 of tubular column body 11); (5) an average first reinforcing rib thickness of 1.70 mm (0.067 in); (6) a luer tip on the outlet port with six ribs thereon; and (7) a column volume capacity of 330 g.

A cap member having a configuration substantially identical to exemplary cap member 12 shown in FIG. 1 was also formed from REPOL® SRM100NC random copolymer (Reliance Polymers, Mumbai, India) via a second injection molding step. The resulting cap member had the following features: (1) a cap member base outer diameter (e.g., the outer diameter of lower outer periphery 34) of 6.06 cm (2.39 in); (2) a cap flange outer dimension (e.g., the outer diameter of cap flange 17) of 8.64 cm (3.4 in); and (3) a cap member height of 2.39 cm (0.94 in).

The tubular column body was filled with 330 g of silica particles commercially available from W. R. Grace (Columbia, Md.) under the trade designation DAVISIL® silica. The cap member was ultrasonically welded to the open end of the tubular column body via an ultrasonic welder, Model. No. GXE3500-20/2050, commercially available from Sonics and Materials Inc.

The resulting column had an operational pressure capacity of greater than 7 kg/cm² (i.e., 100 psi) and a pressure to column cross sectional area of at least about 1.00.

While the invention has been described with a limited number of embodiments, these specific embodiments are not intended to limit the scope of the invention as otherwise described and claimed herein. It may be evident to those of ordinary skill in the art upon review of the exemplary embodiments herein that further modifications, equivalents, and variations are possible. All parts and percentages in the examples, as well as in the remainder of the specification, are by weight unless otherwise specified. Further, any range of numbers recited in the specification or claims, such as that representing a particular set of properties, units of measure, conditions, physical states or percentages, is intended to literally incorporate expressly herein by reference or otherwise, any number falling within such range, including any subset of numbers within any range so recited. For example, whenever a numerical range with a lower limit, R_{L}, and an upper limit R_{U}, is disclosed, any number R falling within the range is specifically disclosed. In particular, the following numbers R within the range are specifically disclosed: R=R_{L}+k(R_{U}−R_{L}), where k is a variable ranging from 1% to 100% with a 1% increment, e.g., k is 1%, 2%, 3%, 4%, 5% . . . 50%, 51%, 52% . . . 95%, 96%, 97%, 98%, 99%, or 100%. Moreover, any numerical range represented by any two values of R, as calculated above is also specifically disclosed. Any modifications of the invention, in addition to those shown and described herein, will become apparent to those skilled in the art from the foregoing description and accompanying drawings. Such modifications are intended to fall within the scope of the appended claims. All publications cited herein are incorporated by reference in their entirety.

While the specification has been described in detail with respect to specific embodiments thereof, it will be appreciated that those skilled in the art, upon attaining an understanding of the foregoing, may readily conceive of alterations to, variations of, and equivalents to these embodiments. Accordingly, the scope of the present invention should be assessed as that of the appended claims and any equivalents thereto.

What is claimed is:

1. A chromatography column comprising:
(a) a tubular column body comprising an open end, a column flange extending outwardly from and integrally connected to said open end, a closed end, and an outlet port positioned within said closed end;
(b) a cap member comprising a cap member flange and an integrally connected inlet port positioned within said cap member; and
(c) one or more bonds connecting a lower surface of said cap member flange to an upper surface of said column flange,
(d) wherein said chromatography column is capable of withstanding a column operational pressure equal to or greater than about 7 kg/cm² (100 psi) and a pressure to column cross sectional area of at least about 1.00.

2. The column of claim 1, wherein said one or more bonds comprise one or more ultrasonically welded bond areas.

3. The column of claim 1, wherein said cap member further comprises a vertically extending side wall surface that contacts an inner side surface of said tubular column body along said open end.

4. The column of claim 3, wherein said vertically extending side wall surface forms a lower outer periphery of said cap member, wherein substantially all of said lower outer periphery of said cap member contacts said inner side surface of said tubular column body along said open end.

5. The column of claim 1, further comprising one or more first reinforcing ribs extending from a lower surface of said column flange to an outer side surface of said tubular column body.

6. The column of claim 1, further comprising one or more second reinforcing ribs extending along an outer end surface of said closed end between said outlet port and an outer periphery of said closed end.

7. The column of claim 1, wherein said cap member further comprises a lower cap surface that forms an upper boundary of a column volume within said tubular column body, said lower cap surface having a surface configuration that enables substantially uniform distribution of an incoming fluid across a cross-sectional area of said column volume.

8. The column of claim 1, wherein said cap member and said tubular column body independently comprise a polymeric material.

9. A chromatography column comprising:
(a) a tubular column body having an open end, a closed end, an outlet port positioned within said closed end, and a thread-less outer surface extending from said open end to said closed end; and
(b) a cap member comprising an inlet port integrally connected to and positioned within said cap member, said cap member being bonded to said tubular column body so as to seal said open end,
(c) wherein said chromatography column is capable of withstanding a column operational pressure equal to or greater than about 7 kg/cm² (100 psi) and a pressure to column cross sectional area of at least about 1.00.

10. The column of claim 9, wherein said cap member is ultrasonically bonded to said tubular column body so as to seal said open end.

11. The column of claim 9, wherein said cap member comprises one or more outer cap member surfaces in contact with said tubular column body, said one or more outer cap member surfaces being thread-less surfaces.

12. The column of claim 9, wherein said cap member further comprises a cap flange having a cap flange lower surface that contacts and is bonded to an end surface of said tubular column body at said open end.

13. The column of claim 12, wherein said cap flange lower surface is substantially perpendicular to a vertically extending side wall surface of said cap member, said vertically extending side wall surface contacting an inner side surface of said tubular column body along said open end.

14. The column of claim 9, wherein an outer surface of said column extending from said inlet port to said outlet port consists solely of said cap member and said tubular column body.

15. A chromatography column comprising:
(a) a tubular column body having an open end, a closed end, and an outlet port positioned within said closed end; and
(b) a cap member sealing said open end of said tubular column body, said cap member comprising (i) an inlet port integrally connected to and positioned within said cap member and (ii) one or more outer cap member surfaces in contact with said tubular column body, said one or more outer cap member surfaces being thread-less surfaces,
(c) wherein said chromatography column is capable of withstanding a column operational pressure equal to or greater than about 7 kg/cm² (100 psi) and a pressure to column cross sectional area of at least about 1.00.

16. The column of claim 15, wherein said tubular column body further comprises thread-less outer and inner surfaces extending from said open end to said closed end.

17. A method of making the chromatography column of claim 1 comprising:
(a) forming the tubular column body;
(b) forming the cap member; and
(c) connecting the cap member to the open end of the tubular column body via the one or more bonds.

18. A method of making the chromatography column of claim 9 comprising:
(a) forming the tubular column body;
(b) forming the cap member; and
(c) bonding the cap member to the open end of the tubular column body.

19. A method of making the chromatography column of claim 15 comprising:
(a) forming the tubular column body;
(b) forming the cap member; and
(c) sealing the open end of the tubular column body with the cap member.

20. A method of analyzing a sample that potentially contains at least one analyte, said method comprising the steps of:
(a) introducing the sample into the column of any one of claims 1 to 16.
